(19) United States
(12) Patent Application Publication
(10) Pub. No.: US 2026/0357515 A1
(43) Pub. Date: Nov. 12, 2026

(54) METHOD FOR DEWATERING MICROBIAL CELLULOSE

(71) Applicant: NANOLLOSE LIMITED, Nedlands (AU)

(72) Inventors: Wayne Morris BEST, Gosnells (AU); Boon Aik TAN, Queens Park (AU); Adam Vincent BLAKE, Woodvale (AU)

(73) Assignee: NANOLLOSE LIMITED, Nedlands (AU)

(21) Appl. No.: 19/483,669

(22) PCT Filed: May 10, 2024
(86) PCT No.: PCT/AU2024/050465

§ 371 Date: Nov. 12, 2025

(30) Foreign Application Priority Data
May 12, 2023 (AU) 2023901457

(51) Int. Cl. D21C 9/18; A01G 24/20

(52) U.S. Cl. CPC D21C 9/18; A01G 24/20

(57) ABSTRACT

The present invention relates to a method for dewatering microbial cellulose, the method comprising: contacting a wet microbial cellulose material with a hydrophilic polymer solution; maintaining contact between the wet microbial cellulose material and the hydrophilic polymer solution for a treatment period to remove at least a portion of the water from the wet microbial cellulose material; and removing the dewatered microbial cellulose from the hydrophilic polymer solution, the present invention further relates to a dewatered microbial cellulose material, the dewatered microbial cellulose material comprising: 25-95% microbial cellulose by dry weight; and 5-75% hydrophilic polymer by dry weight.

### TECHNICAL FIELD

The present invention relates to a method for dewatering microbial cellulose. More specifically, the method of the present invention produces a dewatered microbial cellulose with improved water absorption and retention capacities. The present invention further relates to a dewatered microbial cellulose material.

The present invention further relates to a method for producing plant growth media. More specifically, the present invention provides a method for dewatering microbial cellulose to produce a plant growth media. The present invention further relates to a plant growth medium.

### BACKGROUND ART

The following discussion of the background art is intended to facilitate an understanding of the present invention only. The discussion is not an acknowledgement or admission that any of the material referred to is or was part of the common general knowledge as at the priority date of the application.

Microbial cellulose, also referred to as bacterial cellulose, is a natural cellulose that is synthesized by bacteria. Microbial cellulose is produced as thin fibrils having a typical diameter of 20-100 nm. The thin fibrils intertwine and form a dense three-dimensional matrix. Microbial cellulose has high water retention due to being very hydrophilic and having a high surface area to mass ratio. The water content of the wet microbial cellulose in its original state is ~99%. The produced wet microbial cellulose forms as a gelatinous pellicle.

The raw microbial cellulose pellicle may be dried by evaporating the water from within the fibre matrix. However, it has been found that drying the material causes irreversible internal hydrogen bonding. This process is also referred to as ‘hornification’. Without wishing to be bound by theory, it is understood that water bridges microbial cellulose fibres with hydrogen bonds, maintaining the fibre separation. Dehydration due to water loss via evaporation removes these bridges, resulting in the agglomeration and stacking of the microbial cellulose fibres. The hornification of the microbial cellulose drastically reduces its water absorption and retention capacities. Depending on the temperature and conditions, the dried material is unable to rehydrate beyond 1-10× its weight in water. To maintain the original water retention properties of the microbial cellulose, the raw microbial cellulose must be maintained in a wet state, which adds complexity to the storage and transport of the microbial cellulose material.

One useful application of microbial cellulose is as a plant growth media. The primary reason for this is the high water absorption and retention capacities of the material. However, the loss of water absorption and retention capacity upon drying means that the microbial cellulose must be maintained in its wet state to take full advantage of these properties. This increases the transport and storage costs of the product. While a dried microbial cellulose may still be rehydrated for use as a plant growth media, the drying process will reduce the water absorption and retention capacity of the rehydrated material, impacting its performance as a plant growth media.

Throughout this specification, unless the context requires otherwise, the word “comprise” or variations such as “comprises” or “comprising”, will be understood to imply the inclusion of a stated integer or group of integers but not the exclusion of any other integer or group of integers.

The invention described herein may include one or more range of values (e.g. size, displacement and field strength etc). A range of values will be understood to include all values within the range, including the values defining the range, and values adjacent to the range which lead to the same or substantially the same outcome as the values immediately adjacent to that value which define the boundary to the range.

### SUMMARY OF INVENTION

In accordance with a first aspect of the present invention, there is provided a method for dewatering microbial cellulose, the method comprising:
contacting a wet microbial cellulose material with a hydrophilic polymer solution;
maintaining contact between the wet microbial cellulose material and the hydrophilic polymer solution for a treatment period to remove at least a portion of the water from the wet microbial cellulose material; and
removing the dewatered microbial cellulose from the hydrophilic polymer solution.

The inventors of the present invention have determined that the contact between the wet microbial cellulose and the hydrophilic polymer solution will result in the removal of at least a portion of the water from the wet microbial cellulose and replace it with the hydrophilic polymer.

In one form of the present invention, the method further comprises the step of:
drying the dewatered microbial cellulose to produce a dried microbial cellulose material.

The inventors of the present invention have found that conventional drying methods may be used to remove the remainder of the water from the dewatered microbial cellulose to produce a dried microbial cellulose material. The removal of at least a portion of the water from the microbial cellulose using a hydrophilic polymer solution has been found to improve the water absorption and retention capacities of the dried microbial cellulose. Without wishing to be bound by theory, it is understood that the inclusion of the hydrophilic polymer will at least partially preserve the structure of the microbial cellulose throughout subsequent drying, improving the water absorption and retention capacities of the dried material.

In one form of the present invention, the microbial cellulose material is produced by any suitable bacterium species known in the art, for example Sarcina sp., Agrobacterium sp., Komagataeibacter sp. and Acetobacter sp.

Throughout this specification, unless the context requires otherwise, the term “wet microbial cellulose” or variations thereof, will be understood to refer to a microbial cellulose material that has a water content of at least 90 wt %. Preferably, the wet microbial cellulose has a water content of at least 95 wt %. More preferably, the wet microbial cellulose has not previously been dried.

Throughout this specification, unless the context requires otherwise, the term “dewatered microbial cellulose” or variations thereof, will be understood to refer to a wet microbial cellulose material that has had at least 50 wt % of the starting water content removed. The starting water content being the water content of the wet microbial cellulose prior to treatment.

A method according to any of the preceding claims, wherein the water content of the dewatered microbial cellulose 50% or less than the water content of the wet microbial cellulose.

In one form of the present invention, the wet microbial cellulose is provided as a microbial cellulose pellicle or segments thereof. Throughout this specification, unless the context requires otherwise, the term “microbial cellulose pellicle” or variations thereof, will be understood to refer to a microbial cellulose material produced by static fermentation. Those skilled in the art would recognise that statically fermented microbial cellulose is produced by bacteria as a three-dimensional matrix of microbial cellulose fibrils. This matrix forms as a dense pellicle having a gelatinous membrane-like morphology. The term “microbial cellulose pellicle” will be understood to exclude microbial cellulose material produced by agitated fermentation. Preferably, the microbial cellulose material is not subjected to a homogenisation or pulping process prior to being treated using the method of the present invention.

In one form of the present invention, the wet microbial cellulose pellicle is cut into segments prior to being treated using the method of the present invention. Preferably, the wet microbial cellulose pellicle segments have a minimum size of 1 cm3.

In one form of the present invention, the microbial cellulose content of the wet microbial cellulose material is less than 5 wt %. Preferably, the microbial cellulose content of the wet microbial cellulose material is 0.5-1.0 wt %.

Preferably, the hydrophilic polymer solution comprises one or more polysaccharides. More preferably, the polysaccharide is selected from one or more of guar gum, gum acacia, iota-carrageenans, carboxymethyl cellulose (CMC) and alginates. Still preferably, the hydrophilic polymer solution is a CMC solution. The carboxymethyl cellulose used is preferably an alkali metal salt of carboxymethyl cellulose. For example, the sodium, potassium, or ammonium salt of CMC. Unless otherwise stated, the CMC referred to in the present specification is the sodium salt of CMC.

Preferably, the concentration of the hydrophilic polymer solution is less than 20%. More preferably, the concentration of the hydrophilic polymer solution is less than 10%. In one form of the present invention, the concentration of the hydrophilic polymer solution is 2-10%. In an alternative form of the present invention, the concentration of the hydrophilic polymer solution is 2-6%. In an alternative form of the present invention, the concentration of the hydrophilic polymer solution is 1-3%.

In one form of the present invention, the ratio of hydrophilic polymer solution to wet microbial cellulose is at least 0.5:1. In one form of the present invention, the ratio of hydrophilic polymer solution to wet microbial cellulose is at least 1:1. In one form of the present invention, the ratio of hydrophilic polymer solution to wet microbial cellulose is at least 2:1.

Preferably, the wet microbial cellulose material is submerged in the hydrophilic polymer solution.

In one form of the present invention, the treatment period is at least 6 hours. Preferably, the treatment period is at least 12 hours. More preferably, the treatment period is at least 24 hours. Still preferably, the treatment period is at least 48 hours.

In one form of the present invention, the contact of the wet microbial cellulose material and the hydrophilic polymer solution is conducted at ambient temperature.

In an alternative form of the present invention, the contact of the wet microbial cellulose material and the hydrophilic polymer solution is conducted at elevated temperature. In one form of the present invention, the temperature is between 50-100 °C. In another form of the present invention, the temperature is between 50-70 °C. In one form of the present invention, the elevated temperature is maintained during the treatment period. In an alternative form of the present invention, the elevated temperature is maintained for a portion of the treatment period.

In one form of the present invention, the weight of the dewatered microbial cellulose is less than 40% of the weight of the wet microbial cellulose material. Preferably, the weight of the dewatered microbial cellulose is 5-20% of the weight of the wet microbial cellulose material.

In one form of the present invention, the dewatered microbial cellulose is contacted with further hydrophilic polymer solution to remove additional water.

In one form of the present invention, drying of the dewatered microbial cellulose is conducted at ambient temperatures. In an alternative form of the present invention, drying of the dewatered microbial cellulose is conducted at elevated temperatures.

In one form of the present invention, the dried microbial cellulose is subjected to a size reduction process.

In accordance with a second aspect of the present invention, there is provided a dewatered microbial cellulose material produced by the method of the first aspect of the present invention.

In accordance with a third aspect of the present invention, there is provided a dewatered microbial cellulose material, the dewatered microbial cellulose material comprising:
25-95% microbial cellulose by dry weight; and
5-75% hydrophilic polymer by dry weight.

Preferably, the hydrophilic polymer comprises one or more polysaccharides. More preferably, the polysaccharide is selected from one or more of guar gum, gum acacia, iota-carrageenans, carboxymethyl cellulose (CMC) and alginates. Still preferably, the hydrophilic polymer is CMC.

Preferably, the hydrophilic polymer content is 5-60% by dry weight.

In accordance with a fourth aspect of the present invention, there is provided a method for drying microbial cellulose, the method comprising:
contacting a wet microbial cellulose material with a hydrophilic polymer solution;
maintaining contact between the wet microbial cellulose material and the hydrophilic polymer solution for a treatment period to remove at least a portion of the water from the wet microbial cellulose material;
removing the dewatered microbial cellulose from the hydrophilic polymer solution; and
drying the dewatered microbial cellulose to produce a dried microbial cellulose material.

In accordance with a fifth aspect of the present invention, there is provided a dried microbial cellulose material produced by the method of the fourth aspect of the present invention.

In accordance with a sixth aspect of the present invention, there is provided a method for producing a plant growth medium, the method comprising:
contacting a wet microbial cellulose material with a hydrophilic polymer solution;
maintaining contact between the microbial cellulose material and the hydrophilic polymer solution for a treatment period to remove at least a portion of the water from the wet microbial cellulose material; and
removing the dewatered microbial cellulose from the hydrophilic polymer solution to obtain a plant growth medium.

Throughout this specification, unless the context requires otherwise, the term “plant growth medium” or variations thereof, will be understood to refer to a medium which may be used to substitute soil as a support for plant growth. Such media provide a substance in which seeds may germinate and provides a support for a plant's root system. It will be understood that that the produced plant growth medium will require the addition of water to enable plant growth.

Microbial cellulose is known to be useful as a plant growth medium due to its high water absorption and retention capacities. However, the drying of microbial cellulose using conventional evaporative drying techniques will greatly diminish the water absorption and retention capacities of the microbial cellulose. The dewatering method of the present invention has been found to produce a dewatered microbial cellulose material with increased water absorption and retention capacities. The increased water absorption and retention capacities is beneficial to the use of the material as a plant growth medium as it increases the volume of water available to the plant.

In one form of the present invention, the method further comprises the step of:
drying the dewatered microbial cellulose to obtain a dried plant growth medium.

The inventors have found that the removal of at least a portion of the water from the wet microbial cellulose using the hydrophilic polymer solution will allow for the remaining water to be removed from the dewatered microbial cellulose using conventional drying methods to produce a dried material with improved water absorption and retention capacities.

In one form of the present invention, the plant growth medium is subjected to a size reduction process. In one form of the present invention, the dried plant growth medium is subjected to a size reduction process. Whilst seed germination on unprocessed wet microbial cellulose is possible, the inventors have determined that following germination, the roots are unable to penetrate the dense network of fibrils. The roots are therefore unable to take full advantage of water held within the microbial cellulose structure. The inventors have discovered that reducing the particle size of the microbial cellulose allows for penetration of plant roots, while retaining water retention properties required for suitability as a plant growth medium. Advantageously, unlike the dense network of the unprocessed microbial cellulose, the roots of the plant seed are able to penetrate the size reduced material and gain the structural support of a properly developing root system. Furthermore, it has been found that the reduction in particle size will also increase the rate of water absorption. In one form of the present invention, the size reduction process reduces the particle size of the dried plant growth medium to D90 below 1000 μm. In one form of the present invention, the size reduction process reduces the particle size of the dried plant growth medium to D50 below 500 μm. In one form of the present invention, the size reduction process reduces the particle size of the dried plant growth medium to D10 above 50 μm.

Preferably, the size reduction process is a mechanical size reduction process.

In one form of the present invention, the method further comprises the contact of the plant growth media with water. Preferably, the mixture of plant growth media and water is agitated.

In accordance with a seventh aspect of the present invention, there is provided a plant growth medium produced by the method of the fourth aspect of the present invention.

In accordance with an eighth aspect of the present invention, there is provided a plant growth medium, the plant growth medium comprising:
25-75% microbial cellulose by dry weight; and
25-75% hydrophilic polymer by dry weight.

Preferably, the hydrophilic polymer content is 30-60% by dry weight.

Preferably, the hydrophilic polymer is selected from one or more polysaccharides. More preferably, the polysaccharide is selected from one or more of guar gum, gum acacia, iota-carrageenans, carboxymethyl cellulose (CMC) and alginates. Still preferably, the hydrophilic polymer is CMC.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a graph showing the reduction of pellicle thickness during contact with the hydrophilic polymer solution; and

FIG. 2 is a graph showing the water retention of dried material with varying particle size.

### DESCRIPTION OF EMBODIMENTS

The present invention relates to a method for dewatering microbial cellulose. The method of the present invention comprises the contact of wet microbial cellulose with a hydrophilic polymer solution to reduce the water content of the wet microbial cellulose. The dewatered microbial cellulose is then removed from the hydrophilic polymer solution. The method of the present invention has been found to improve the water absorption and retention capacities of the dewatered product over conventional drying methods. The method of the present invention has also been found to reduce the energy required to remove water from the wet microbial cellulose material. In certain embodiments, the dewatered material may be subjected to a drying step to remove the remaining water and produce a dried microbial cellulose material.

### Microbial Cellulose

The method of the present invention is intended to remove water from wet microbial cellulose. Throughout this specification, unless the context requires otherwise, the term “microbial cellulose”, means cellulose produced by bacteria.

Microbial cellulose for use in the methods of the present invention can be produced by a variety of means well known in the art.

In a preferred form of the invention, the microbial cellulose is microbial cellulose produced by bacteria of the genus Acetobacter. Bacteria of the genus Acetobacter can be readily identified by persons skilled in the art by the growth of colonies on a medium containing about 7% ethanol and enough calcium carbonate to render it partially opaque. When Acetobacter colonies form enough acetic acid from the ethanol, the calcium carbonate around the colonies dissolves, forming a very distinct clear zone.

In static fermentation processes, microbial cellulose forms as a sheetlike pellicle on the surface of the culture medium. As growth continues, the thickness of the raw microbial cellulose pellicle increases. The wet microbial cellulose material is harvested once the desired thickness is reached. Harvesting the wet microbial cellulose material comprises removing the microbial cellulose pellicle from the culture medium. In one embodiment, the thickness of the microbial cellulose is between 0.5-5 cm. In one embodiment, the thickness of the microbial cellulose is between 0.5-4 cm. In one embodiment, the thickness of the microbial cellulose is between 0.5-3 cm. In one embodiment, the thickness of the microbial cellulose is between 0.5-2 cm. In one embodiment, the thickness of the microbial cellulose is between 0.5-1 cm.

In certain embodiments, the wet microbial cellulose is washed prior to contact with the hydrophilic polymer solution. Washing preferably comprises heating the wet microbial cellulose in water at a temperature between 60 °C and 100 °C. The wet microbial cellulose may be washed several times.

In certain embodiments, the wet microbial cellulose is subjected to a purification step prior to contact with the hydrophilic polymer solution. The purification step preferably comprises contacting the wet microbial cellulose with a detergent.

The wet microbial cellulose should have not been dried prior to contact with the hydrophilic polymer solution.

Contact with Hydrophilic Polymer Solution

The wet microbial cellulose is contacted with a hydrophilic polymer solution and the contact is maintained for a treatment period. The contact of the microbial cellulose with the hydrophilic polymer solution removes a portion of the water from the wet microbial cellulose. Without wishing to be bound by theory, it is theorised that the hydrophilicity of the hydrophilic polymer is larger than the microbial cellulose, resulting in the water being drawn out from within the wet microbial cellulose. The contact of the microbial cellulose with the hydrophilic polymer solution also allows the hydrophilic polymer to infuse into the structure of the microbial cellulose. This is understood to reduce the degree of hornification within the structure when the remaining water is removed, thereby providing a dried material with a higher water absorption and retention capacities.

Preferably, the wet microbial cellulose material is provided as a pellicle or segments thereof. It should be understood that the microbial cellulose pellicle treated by the present invention may be divided into smaller segments prior to contact with the hydrophilic polymer solution. The structure of the microbial cellulose should be otherwise unchanged. The wet microbial cellulose that is contacted with the hydrophilic polymer solution should not have previously been subjected to a homogenisation process or similar pulping process. As would be appreciated by a person skilled in the art, the homogenisation of raw microbial cellulose will break up the dense network of fibrils and form a pulp of ground microbial cellulose. The inventors of the present invention have found that the contact of such a pulp with a hydrophilic polymer solution does not allow for the dewatered microbial cellulose to be readily separated from the aqueous phase. Furthermore, the wet microbial cellulose that is contacted with the hydrophilic polymer solution should not have been produced in an agitated fermentation process. Microbial cellulose produced by agitated fermentation has a pulp-like consistency and similar separation problems are encountered.

Preferably, the wet microbial cellulose is submerged in the hydrophilic polymer solution.

Preferably, the hydrophilic polymer solution comprises one or more polysaccharides. More preferably, the polysaccharide is selected from one or more of guar gum, gum acacia, iota-carrageenans, carboxymethyl cellulose (CMC) and alginates. Still preferably, the hydrophilic polymer solution is a CMC solution.

Preferably, the concentration of the hydrophilic polymer solution is less than 20%. More preferably, the concentration of the hydrophilic polymer solution is less than 10%.

The inventors have found that the maximum concentration of the hydrophilic polymer solution is dependant on the viscosity of the hydrophilic polymer solution. If the viscosity is too high, then the polymer solution becomes a thick gel, reducing its efficiency and making it harder to work with. As would be appreciated by a person skilled in the art, the viscosity of hydrophilic polymer solutions is a factor of the polymer type, the concentration of the polymer and the solution temperature. Polymers with higher average molecular weight demonstrate higher viscosity in solution than those with lower molecular weight. Accordingly, the maximum concentration of hydrophilic polymer is dependent on the average molecular weight of the hydrophilic polymer solution.

As would be appreciated by a person skilled in the art, polymer compositions comprise polymer chains comprising repeating monomeric units. The degree of polymerization (DP) is the number of monomeric units in a polymer molecule. The molecular weight of a particular polymer molecule is a product of the degree of polymerization and the molecular weight of the repeating unit. Polymer compositions are composed of many polymer molecules having various chain lengths and molecular weights. This results in the polymer having a distribution of molecular weights. The average molecular weight of a polymer can be described by a number of parameters. For the purposes of the present application, the average molecular weight of the polymer will be the weight-average molecular weight (M_{w}). The weight-average molecular weight of a polymer is well defined in the literature and can be determined by analytical methods, such as gel permeation chromatography.

In embodiments where the M_{w} of the hydrophilic polymer is less than 150,000, the concentration of the hydrophilic polymer solution is preferably between 2-10%.

In embodiments where the M_{w} of the hydrophilic polymer is between 150,000-500,000, the concentration of the hydrophilic polymer solution is preferably between 2-6%.

In embodiments where the M_{w} of the hydrophilic polymer solution is greater than 500,000, the concentration of the hydrophilic polymer solution is preferably between 1-3%.

The inventors have found that the average molecular weight of the hydrophilic polymer solution will also impact the extent of water removal from the wet microbial cellulose and the water absorption capacity of the resulting dried material. Lowering the average molecular weight of the hydrophilic polymer solution reduces the amount of water that is removed from the wet microbial cellulose but increases the polymer content of the resulting dried material. Increasing the average molecular weight of the hydrophilic polymer increases the amount of water that is removed from the wet microbial cellulose but decreases the polymer content of the resulting dried material. Selection of the hydrophilic polymer may therefore be used to preference increased water removal, increased swelling preservation or a mixture of each.

In one embodiment of the present invention, the hydrophilic polymer solution comprises a mixture of a low average molecular weight (LMw) hydrophilic polymer and a high average molecular weight (HMw) hydrophilic polymer. The inventors have found that the inclusion of hydrophilic polymers with different average molecular weights can improve the overall water removal and polymer content of the dried product. Without wishing to be bound by theory, it is understood that the smaller molecular size of the LMw hydrophilic polymer allows it to penetrate the microbial cellulose matrix more efficiently, which in turn reduces its dewatering effect, whereas the opposite is true for the larger molecular sized HMw hydrophilic polymer.

In one embodiment, the hydrophilic polymer solution comprises 1-2% HMw hydrophilic polymer and 0.5-4% LMw hydrophilic polymer. In one embodiment, the hydrophilic polymer solution comprises 1-2% HMw hydrophilic polymer and 2-4% LMw hydrophilic polymer.

In embodiments where the hydrophilic polymer solution comprises two or more hydrophilic polymers of known average molecular weights, the weighted average of each hydrophilic polymer may be used to determine the total average molecular weight of the hydrophilic polymer. Similarly, the total concentration of the hydrophilic polymer solution is the total weight % of each respective hydrophilic polymer.

In one embodiment, the ratio of hydrophilic polymer solution to wet microbial cellulose is at least 0.5:1. In one embodiment, the ratio of hydrophilic polymer solution to wet microbial cellulose is at least 1:1. In one embodiment, the ratio of hydrophilic polymer solution to wet microbial cellulose is at least 2:1. The removal of water from the wet microbial cellulose into the hydrophilic polymer solution will dilute the hydrophilic polymer solution. As discussed above, the concentration of the hydrophilic polymer solution should be maintained above a certain concentration to ensure that sufficient water is removed from the wet microbial cellulose. The ratio of hydrophilic polymer solution should be controlled to ensure that the concentration of the hydrophilic polymer solution is not diluted below the minimum concentration. The ratio will be impacted by the starting concentration of the hydrophilic polymer solution.

In one form of the present invention, the treatment period is at least 6 hours. In one embodiment, the treatment period is at least 12 hours. In one embodiment, the treatment period is at least 24 hours. In one embodiment, the treatment period is at least 48 hours. The contact of the wet microbial cellulose and the hydrophilic polymer solution must be maintained for a sufficient time to reduce the water content of the microbial cellulose and for the hydrophilic polymer to diffuse into the microbial cellulose structure. The inventors understand that the removal of water is a relatively rapid process, whereas infusion of the CMC occurs relatively slowly. The inventors have found that the concentration of the hydrophilic polymer in the dewatered material will impact the water absorption and retention capacity of the dried product. The treatment time should be controlled to achieve the required hydrophilic polymer concentration. The thickness of the wet microbial cellulose material has been found to influence the required treatment period. The inventors have found that optimal hydrophilic polymer concentration is achieved with a treatment period of 24-72 hours for wet microbial cellulose materials having a thickness of 0.5-1 cm. Extended treatment periods of 72-96 hours may be required to achieve optimal hydrophilic polymer concentration for thicker wet microbial cellulose materials.

In one embodiment of the present invention, the contact of the wet microbial cellulose material and the hydrophilic polymer solution is conducted at ambient temperature. In an alternative embodiment, the hydrophilic polymer solution is heated above 50 °C prior to the contact. The heated hydrophilic polymer solution may be cooled prior to contact with the wet microbial cellulose material.

In an alternative form of the present invention, the contact of the wet microbial cellulose material and the hydrophilic polymer solution is conducted at elevated temperature. In one embodiment, the temperature is between 50-100 °C. In another embodiment, the temperature is between 50-70 °C. In one form of the present invention, the elevated temperature is maintained during the treatment period. In an alternative form of the present invention, the elevated temperature is maintained for a portion of the treatment period. The inventors have found that the contact of the wet microbial cellulose material and the hydrophilic polymer solution at elevated temperatures can increase the rate at which the hydrophilic polymer infuses into the microbial cellulose material. This can reduce the required treatment period.

A further advantage of contacting the wet microbial cellulose material and the hydrophilic polymer solution at elevated temperature prevents bacterial and fungal growth.

### Dewatered Product

Following the completion of the treatment period, the dewatered microbial cellulose material is removed from the hydrophilic polymer solution and excess solution is removed by gently wiping or scraping the surface. The remaining hydrophilic polymer solution can be used to treat further wet microbial cellulose.

The removal of water from the microbial cellulose will result in a material having a much smaller thickness. In one embodiment of the present invention, the weight of the dewatered microbial cellulose is less than 20% of the weight of the wet microbial cellulose material. Preferably, the weight of the dewatered microbial cellulose is 5-20% of the weight of the wet microbial cellulose material. The weight of the dewatered microbial cellulose can be used to determine whether sufficient water has been removed by the hydrophilic polymer solution. If sufficient water has not been removed, the dewatered microbial cellulose may be again contacted with hydrophilic polymer solution to remove further water.

The dewatered microbial cellulose material will have a hydrophilic polymer content. The final hydrophilic polymer content will be the result of the treatment period, the contact temperature, the thickness of the wet microbial cellulose and the concentration of the hydrophilic polymer solution and the type of hydrophilic polymer used. In one embodiment, the dewatered microbial cellulose material has 5-75% hydrophilic polymer by dry weight. The hydrophilic polymer content has been found to influence the water absorption and retention capacities of the dried microbial cellulose material. A hydrophilic polymer content of 30-60% by dry weight has been found to result in a dewatered material demonstrating improved water absorption capacity. However, polymer content as low as 5% by dry weight, which result from more efficient dewatering, can still prevent hornification and allow the material to absorb and retain sufficient water for certain applications. A hydrophilic polymer content above 75% by dry weight becomes detrimental to water absorption and retention capacities as there is insufficient microbial cellulose in the material upon rehydration. The hydrophilic polymer content may be controlled to suit the desired purpose by selection of the polymer used and adjusting the treatment period, the contact temperature, the thickness of the wet microbial cellulose and the concentration of the hydrophilic polymer solution.

The method of the present invention produces a dewatered microbial cellulose product that may be rapidly rehydrated. The removal of water from the wet microbial cellulose reduces the weight and thickness of the cellulose material, which is envisaged to be advantageous for the shipping and storage of microbial cellulose materials. The dewatering method of the present invention allows for water to be removed for shipping and storage without substantially impacting the rehydration of the dewatered material. It is envisaged that the dewatered material may also be useful in applications where additives, such as antibiotics, vitamins and the like, are to be introduced into the microbial cellulose. Such additives may be absorbed into the dewatered microbial cellulose during the rehydration. The dewatered microbial cellulose is also expected to enable the use of unstable additives, which would otherwise degrade in shipping and storage, at the point of use.

As the dewatering method of the present invention will not fully remove all the water from the wet microbial cellulose, the resulting dewatered microbial cellulose is a hydrated material. The dewatered microbial cellulose material is suitable for applications where a hydrated material is preferable. It is envisaged that such application may include cosmetic applications, such as skin treatments, and health care applications, such as wound treatments. The hydrated material is also suitable for application where a flexible material is useful.

### Drying

In one embodiment of the present invention, the dewatered microbial cellulose is subjected to a drying step to remove the remaining water in the material. The inventors have found that at least a substantial portion of the remaining water in the dewatered microbial cellulose may be removed to produce a dried material. Advantageously, the dried material has been found to exhibit improved water absorption and retention capacities over dried microbial cellulose produced using only conventional drying techniques. Removing the remaining water from the dewatered microbial cellulose material will further reduce the weight and thickness of the microbial cellulose, thereby reducing shipping/transport costs. The method of the present invention also prevents the need for wet microbial cellulose to be stored in controlled environments to prevent unintentional drying. The high water absorption and retention capacities of the dried material is envisaged to also allow it to be used as biodegradable absorbent material.

Preferably, an evaporative drying process is used to dry the dewatered microbial cellulose materials. Throughout the specification, the term “evaporative drying process” will be understood to include any process which results in the evaporation of water from within the dewatered wet microbial cellulose materials. Suitable evaporative drying processes include, air drying, convention drying, contact drying, radiation drying including infra-red, dielectric drying, including microwave, high frequency drying, freeze drying, and vacuum drying. In one embodiment, drying of the dewatered microbial cellulose is conducted at ambient temperatures. In an alternative embodiment, drying of the dewatered microbial cellulose is conducted at elevated temperatures. Preferably, drying is conducted at temperatures of at least 70 °C.

### Size Reduction

The dewatered material may be retained in its original shape. Alternatively, the dewatered material may be subjected to a size reduction process. The inventors have found that the particle size of the dewatered material can be freely reduced without significantly impacting the water absorption capacities. In an embodiment where the method comprises a drying step, the dried material may be retained in its original shape. Alternatively, the dried material may be subjected to a size reduction process. The inventors have found that the particle size of the dried material can be freely reduced without significantly impacting the water absorption capacities.

### Product

The present invention further relates to a dewatered microbial cellulose product produced using the dewatering process described above.

In one embodiment, the dewatered microbial cellulose material comprises:
25-95% microbial cellulose by dry weight; and
5-75% hydrophilic polymer by dry weight.

Preferably, the hydrophilic polymer concentration is 5-60% by dry weight.

The present invention further relates to a dried microbial cellulose product produced using the drying process described above.

In one embodiment, the dried microbial cellulose material comprises:
25-95% microbial cellulose; and
5-75% hydrophilic polymer.

Preferably, the hydrophilic polymer concentration is 5-60%.

### Growth Material

The present invention further relates to a method for producing a plant growth medium, the method comprising:
contacting a wet microbial cellulose material with a hydrophilic polymer solution;
maintaining contact between the microbial cellulose material and the hydrophilic polymer solution for a treatment period; and
removing the dewatered microbial cellulose from the solution to obtain a plant growth medium.

Microbial cellulose is known to be useful as a plant growth medium due to its high water absorption and retention capacities. However, the drying of microbial cellulose using conventional evaporative drying techniques will greatly diminish the water absorption and retention capacities of the microbial cellulose. The dewatering method of the present invention has been found to produce a dewatered microbial cellulose material with increased water absorption and retention capacities. The increased water absorption and retention capacities is beneficial to the use of the material as a plant growth medium as it increases the volume of water available to the plant.

The plant growth medium of the present invention is intended to be reconstituted with water in order the make it suitable for plant growth. Advantageously, the inventors have determined that the applicability of the method of the present invention allows for the cost-effective dewatering and transport of the dewatered microbial cellulose from locations where it is produced to locations where it is to be used as a plant growth media.

The discussion of the method of dewatering microbial cellulose according to the first aspect of the present similarly applies to the dewatering process used to produce the plant growth medium.

Preferably, the hydrophilic polymer solution comprises one or more polysaccharides. More preferably, the polysaccharide is selected from one or more of guar gum, gum acacia, iota-carrageenans, carboxymethyl cellulose (CMC) and alginates. Still preferably, the hydrophilic polymer solution is a CMC solution.

In one embodiment, the method further comprises the step of:
drying the dewatered microbial cellulose to produce a dried plant growth medium.

In a preferred embodiment, the dried plant growth medium is subjected to a size reduction process. The inventors have found that the reduction in particle size will assist with the penetration of plant roots into the plant growth media. Furthermore, it has been found that the reduction in particle size will also increase the rate of water absorption.

In one embodiment, the size reduction process reduces the particle size of the dried plant growth medium to D90 below 1000 μm.

In one embodiment, the size reduction process reduces the particle size of the dried plant growth medium to D50 below 500 μm. Preferably, the size reduction process reduces the particle size of the dried plant growth medium to D50 below 400 μm.

In one embodiment, the size reduction process reduces the particle size of the dried plant growth medium to D10 above 50 μm.

As would be understood by a person skilled in the art, particle size distributions are often expressed using D values. The meanings of the respective D values, are:
D10: size under which 10% by volume of the particles are below;
D50: size under which 50% by volume of the particles are below; and
D90: size under which 90% by volume of the particles are below.

For the purposes of the present invention, the term “particle size” is defined as the dimension of a particle which is determined by a sieve size analysis according to the Sieving Test described in greater detail herein. A sample of particles is sieved as described, and the results are recorded. The results of such a sieve size analysis sufficiently define the size of the particles for the purposes of the present invention. The results of the sieve analysis may be expressed by two equivalent conventions in terms of the characteristics of the sieves used. One way to express the size of the particles is in terms of the size of the openings in the sieves. For instance, in principal, a particle that is retained on a sieve with 500 μm openings is considered to have a particle size greater than or equal to 500 μm for the purposes of the present invention. A particle that passes through a sieve with 500 μm openings and is retained on a sieve with 100 μm openings is considered to have a particle size between 100 and 500 μm.

As would be appreciated by a person skilled in the art, for non-spherical particles, the sieving test may determine the size of only certain dimensions of a specific particle. In the case of elongate particles, the shorter dimension of the particle may pass through the apertures of the mesh, resulting in particles with larger cross sections passing through the mesh. Because of this, the test results are generally expressed in terms of the percentage of particles, by volume, which will ordinarily pass through a sieve of one dimension and be retained on a sieve of a second dimension.

Preferably, the size reduction process is a mechanical size reduction process. As would be understood by a person skilled in the art, mechanical size reduction processes will break the material under a stress applied by a mechanical force. The mechanical force may be selected from one or more of a tensile stress, bending stress, compressive stress, torsional stress, impact stress and shearing stress. Preferably, the mechanical force is any one or more of compressive stress, impact stress and shearing stress.

The inventors have found that mechanical size reduction using high speed rotating blades is particularly useful. In such processing, it is understood that the mechanical force primarily consists of the impact force generated from the collision between the rotating blades and the microbial cellulose and of the shearing force generated due to differences of the speed in the medium. As would be understood by a person skilled in the art, any apparatus that is capable of applying the mechanical force to the microbial cellulose will be suitable. Preferably, the apparatus is a blender.

In one form of the present invention, the method further comprises the contact of the plant growth media with water. Preferably, the mixture of plant growth media and water is agitated.

### Example 1

A series of trials were conducted to test the effect that hydrophilic polymer M_{w} and hydrophilic polymer concentration had on the dewatering of the wet microbial cellulose. Fourteen (14) CMC solutions were prepared using low M_{w} CMC (90,000), medium Mw CMC (250,000) and high M_{w} CMC (700,000). The CMC concentration in the solutions ranged from 0.5% to 10% depending on the M_{w} of the CMC solution. In each test, pieces of raw wet microbial cellulose pellicles ~70-80 g (unblended) were weighed and submerged in beakers containing 500 g of each CMC solution. The pellicles were held in the CMC solution and were left at room temperature. After 24 hours, the pellicles were removed from the solution and scraped of excess CMC solution. The resulting material was then dried. The results are shown in Table 1.

TABLE 1
Comparison of Single CMC Types (at varying CMC percentages)

| | Low M_{w} | | | Medium M_{w} | | | High M_{w} | | |
|---|---|---|---|---|---|---|---|---|---|
| CMC | De- | | | De- | | | De- | | |
| Solution | Watering | | CMC | Watering | | CMC | Watering | | CMC |
| (%) | (%) | Swelling | (%) | (%) | Swelling | (%) | (%) | Swelling | (%) |
| 0.5 | −7.4% | 71x | 32% | Not tested | Not tested | Not tested | 64% | 18x | 5.5% |
| 1.0 | −5.0% | 124x | 55% | Not tested | Not tested | Not tested | 88% | 34x | 4.6% |
| 1.5 | −0.3% | 135x | 62% | Not tested | Not tested | Not tested | 90% | 25x | 5.6% |
| 2.0 | 2.8% | 151x | 69% | Not tested | Not tested | Not tested | 92% | 32x | 5.8% |
| 2.5 | 8.8% | 148x | 73% | Not tested | Not tested | Not tested | 93% | 32x | 5.6% |
| 3.0 | 15% | 156x | 76% | 88% | 84x | 33% | 93% | 26x | 6.3% |
| 10 | 82% | 135x | 63% | Not tested | Not tested | Not tested | Too Viscous | Too Viscous | Too Viscous |

CMC content was calculated using an untreated sample of wet microbial cellulose treated in 500 g of water then dried and weighed to discover the dried MC weight vs wet pellicle weight. This percentage was then used to calculate the dry weight of the pellicle without CMC, which can be subtracted from the dried weight to discover the estimated CMC percentage.

De-watering was measured by weighing the wet pellicle prior to treatment, then after 24 hours once excess CMC solution is removed, taking into account the weight of microbial cellulose and CMC present, and calculating the actual percentage of water removed.

Swelling measurements were conducted by submerging approximately 1 g of dried material in 500 ml of water for 72 hours (checking for constant weight to ensure saturation and removal of CMC from the microbial cellulose). The swelling ratio was then calculated by dividing the wet weight of the microbial cellulose obtained by the weight of the microbial cellulose in the dry material (i.e., the total dry weight less the weight of CMC in the material).

Table 1 demonstrates the difference between CMC having different Mw. Low Mw CMC has the lowest de-watering effect but highest CMC absorption/content in the resulting material. High M_{w} CMC has the highest de-watering effect but lowest CMC absorption/content in the resulting material. Medium M_{w} CMC produces a similar de-watering effect as high M_{w} CMC but with a higher CMC uptake (lower than low M_{w} CMC). Therefore, CMC type can be selected for drying alone, swelling preservation alone or both swelling preservation and drying.

### Example 2

A series of trials were conducted to test the effect that a combination of hydrophilic polymers with different M_{w} had on the dewatering of wet microbial cellulose. Five (5) CMC solutions were prepared by combining varying amounts of low M_{w} CMC and high Mw CMC. In each test, pieces of raw wet microbial cellulose pellicles ~70-80 g (unblended) were weighed and submerged in beakers containing 500 g of each CMC solution. The pellicles were held in the CMC solution were left at room temperature. After 24 hours, the pellicles were removed from the solution and scraped of excess CMC solution. The resulting material was then dried. The results are shown in Table 2.

TABLE 2
Mixed High M_{w} (HM_{W}) CMC and Low M_{w} (LM_{W}) CMC

| CMC Type | De-watering | Swelling | CMC Content | Avg. M_{w} (′000) | % CMC |
|---|---|---|---|---|---|
| 2.0% HM_{w} + 0.5% LM_{w} | 91% | 52x | 11% | 578 | 2.5 |
| 2.0% HM_{w} + 1.0% LM_{w} | 90% | 62x | 19% | 497 | 3 |
| 2.0% HM_{w} + 2.0% LM_{w} | 85% | 91x | 25% | 395 | 4 |
| 2.0% HM_{w} + 3.0% LM_{w} | 84% | 119x | 41% | 316 | 5 |
| 2.0% HM_{w} + 4.0% LM_{w} | 85% | 137x | 58% | 293 | 6 |

Table 2 shows that using a mix of CMC types can be beneficial for combining the de-watering effects as well as high swelling preservation. It is theorised that the high Mw CMC produces the de-watering effect whilst the low M_{w} CMC produces better CMC absorption/swelling preservation. The results suggests that other mixtures of hydrophilic polymers with various molecular weights may also be beneficial.

### Example 3

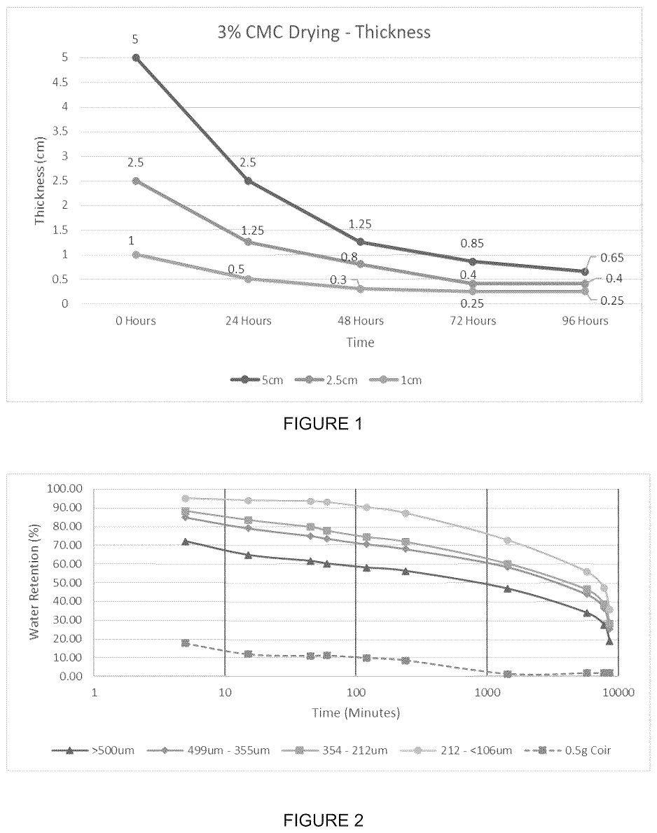

A series of tests were conducted to determine the effect that the thickness of the wet microbial cellulose had on the rate at which water was removed by a high M_{w} CMC solution. Samples of wet microbial cellulose having different starting thickness were treated in a 3% CMC solution. Each sample was circular in shape having a 10 cm diameter. FIG. 1 shows difference in sample thickness over drying time.

These results indicate that a large portion of water is removed after 24 hours and that 48-72 hours of drying time is sufficient to remove the majority of the water. It can be noted that twice thickness does not take double the time to dry.

### Example 4

A series of tests were conducted to determine the effect that temperature during the contact of wet microbial cellulose and high MW CMC solution had on the microbial cellulose after dewatering and drying. The results of the tests are shown in Table 3.

TABLE 3
Heat treatment

| | % of wet weight after | CMC Content in dried | Swelling of dried |
|---|---|---|---|
| Treatment | 72 H in CMC | pellicle | pellicle in water |
| Room Temperature | 15% | 6.5% CMC Content | 56x |
| Oven (70 C) | 18.6% | 35% CMC Content | 100x |
| No Treatment (Raw MC) | N/A | 0% CMC Content | 2-3x |

The oven treatment significantly increases the rate at which CMC is taken up by the microbial cellulose. This is hypothesized to be partly due to viscosity reduction with increased temperature. The untreated material demonstrates the significant swelling loss without CMC drying procedure.

### Example 5

A series of experiments were conducted to determine the effect that CMC concentration in the dried microbial cellulose (MC) had on seed germination. 0.5 g samples of dried microbial cellulose, dried CMC treated microbial cellulose, and CMC (high Mw) were treated with 50 ml of water. Samples were placed into a seed germination tray (holes in bottom to allow excess water to drain), treated with approximately 50 seeds of Brassica juncea, and monitored for 1 week. The results are shown in Table 4.

TABLE 4
Seed Germination Results of Varying CMC Content

| CMC Content | Germination |
|---|---|
| 0% - Control | Germination failed. Insufficient water absorption and retention. Material completely dry |
| | within 24 hours. Insufficient material to support germination and growth. |
| 6.5% | Seeds germinated at day 3 and continued to thrive. Produces lower volume of growth |
| | media than 15-49% CMC due to less water absorption and retention. |
| 15-49% | Seeds germinated at day 3 and continued to thrive. Produces highest volume of growth |
| | media with a balance of solid MC content and high water absorption and retention. |
| 50-90% | Seeds germinated at day 3 and continued to thrive. Produces lower volume of growth |
| | media than 15-49% CMC due to less solid MC content. |
| 100% | Germination failed. Lack of solid MC support not conducive for plant germination and |
| | growth. |

### Example 6

A series of tests were undertaken to determine the effect that the particle size of the dried microbial cellulose had on the water retention of the material following rehydration. Dried samples were produced by contacting wet microbial cellulose with a CMC solution containing 2.3% high MW CMC and 3% low MW CMC for 24 hrs. The dewatered material was removed from the solution and dried at 70 °C. The dried material was blended for 3 minutes in a NutriBullet Rx blender. The resulting powder was passed through a sieve (following AS 1289.3.6.1) and fractions of 106, 212, 355, 425, 500 μm were collected. A sample of coir was also included for comparison.

0.5 g of dried material from each particle size range was added to 50 ml of water and shaken for 2 minutes until a gel forms and water is fully incorporated. A sample of coir was also included for comparison. The resulting mixture was placed on to a pre weighed tray with drainage holes and allowed to drain at room temperature and pressure, weighing at varying intervals to obtain the water retention percentage over time. The results are shown in FIG. 2.

The results show that the water retention is significantly affected by the particle size. Smaller particle sizes cause a higher water retention than larger particle sizes. It is also noted that using the same weight of coir as treated microbial cellulose (0.5 g) completely loses its water content within 24 hours, whilst treated microbial cellulose retains over 25% of its water after 120 hours.

### Example 7

The dried microbial cellulose of the present invention was compared to other commercially available plant growth media comprising coir fibres. The microbial cellulose was treated with 3% solution of high M_{w} CMC at 70 °C for 96 hrs prior to drying at 70 °C. It was then size reduced and passed through a 1 mm sieve. Each coir pellet weighs 3.9-4.1 g (4 g average) and is 3 cm diameter×1.2 cm thick when dry (8.5 cm3 per pellet). Pellets were unwrapped and crumbled to allow free swelling. The test involved determining the dry volume of each material that was required to fill a 6×6×2 cm (L×W×H) or 72 cm3 seed germination tray section following rehydration. The results are shown in Table 5.

TABLE 5
CMC-MC Vs Coir Comparison to produce
72 cm3 seed germination medium

| Material | Dry Volume Required | | Dry Weight Required | |
|---|---|---|---|---|
| Coir | 11 | cm³ | 5 | grams |
| CMC treated MC | 1.4 | cm³ | 0.5 | grams |

The results demonstrate that a significantly less volume (87% less volume) and weight (90% less weight) of dried microbial cellulose is required to achieve the same wet volume as the Coir material.

### COMPARATIVE EXAMPLE

CMC has been used in the prior art as means to prevent hornification when drying microbial cellulose pulps. Such pulps comprise wet microbial cellulose that has been subjected to a comminution process. A test was undertaken to determine where the contact of a microbial cellulose (MC) pulp with a CMC solution would result in the removal of water from the pulp. A 2% MC pulp was mixed with a 2% high M_{w} CMC solution at a ratio of 1:1 and was left overnight at room temperature. The CMC and MC mixture formed a homogeneous gel and no indication of de-watering was observed. It was further noted that treating MC pulp with CMC solution produced a material that was more difficult to de-water than untreated pulp. This was evidenced by attempts to spin-dry both CMC treated and untreated MC pulps through a fine mesh, where water was more readily released from the untreated pulp.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

1. A method for dewatering microbial cellulose, the method comprising:
contacting a wet microbial cellulose material with a hydrophilic polymer solution;
maintaining contact between the wet microbial cellulose material and the hydrophilic polymer solution for a treatment period to remove at least a portion of the water from the wet microbial cellulose material; and
removing the dewatered microbial cellulose from the hydrophilic polymer solution.

2. A method according to claim 1, wherein the wet microbial cellulose is provided as a microbial cellulose pellicle or segments thereof.

3. A method according to claim 1, wherein the microbial cellulose content of the wet microbial cellulose material is less than 5 wt %.

4. A method according to claim 1, wherein the hydrophilic polymer solution comprises one or more polysaccharides.

5. A method according to claim 4, wherein the polysaccharide is selected from one or more of guar gum, gum acacia, iota-carrageenans, carboxymethyl cellulose (CMC) and alginates.

6. A method according to claim 1, wherein the hydrophilic polymer solution is a CMC solution.

7. A method according to claim 1, wherein the concentration of the hydrophilic polymer solution is less than 20%.

8. A method according to claim 1, wherein the ratio of hydrophilic polymer solution to wet microbial cellulose is at least 0.5:1.

9. A method according to claim 1, wherein the treatment period is at least 6 hours.

10. A method according to claim 1, wherein the contact of the wet microbial cellulose material and the hydrophilic polymer solution is conducted at elevated temperature.

11. A method according to claim 1, wherein the weight of the dewatered microbial cellulose is less than 40% of the weight of the wet microbial cellulose material.

12. A method according to claim 1, wherein the method further comprises the step of:
drying the dewatered microbial cellulose to produce a dried microbial cellulose material.

13. A dewatered microbial cellulose material, the dewatered microbial cellulose material comprising:
25-95% microbial cellulose by dry weight; and
5-75% hydrophilic polymer by dry weight.

14. A dewatered microbial cellulose material according to claim 13, wherein the hydrophilic polymer comprises one or more polysaccharides

15. A dewatered microbial cellulose material according to claim 14, wherein the polysaccharide is selected from one or more of guar gum, gum acacia, iota-carrageenans, carboxymethyl cellulose (CMC) and alginates.

16. A dewatered microbial cellulose material according to claim 13, wherein the hydrophilic polymer is CMC.

17. A dewatered microbial cellulose material according to claim 13, wherein the hydrophilic polymer content is 5-60% by dry weight.

18. A method for producing a plant growth medium, the method comprising:
subjecting a wet microbial cellulose material to the dewatering method of claim 1 to obtain a plant growth medium.

19. A method according to claim 18, wherein the method further comprises the step of:
drying the dewatered microbial cellulose to obtain a dried plant growth medium.

20. A method according to claim 19, wherein the dried plant growth medium is subjected to a size reduction process:

21. A method according to claim 20, wherein the size reduction process reduces the particle size of the dried plant growth medium to D90 below 1000 μm.

22. A plant growth medium, the plant growth medium comprising:
25-75% microbial cellulose by dry weight; and
25-75% hydrophilic polymer by dry weight.

23. A plant growth medium according to claim 22, wherein the hydrophilic polymer comprises one or more polysaccharides.

24. A plant growth medium according to claim 23, wherein the polysaccharide is selected from one or more of guar gum, gum acacia, iota-carrageenans, carboxymethyl cellulose (CMC) and alginates.
